(19) United States
(12) Patent Application Publication
(10) Pub. No.: US 2004/0144005 A1
(43) Pub. Date: Jul. 29, 2004

(54) Sound and light swinging device

(76) Inventor: Jean Young, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 10/350,111

(22) Filed: Jan. 24, 2003

(51) Int. Cl. G09F 19/08; G09F 27/00

(52) U.S. Cl. 40/414; 40/455

(57) ABSTRACT

The present invention relates to a sound and light swinging device, more particularly to a swinging device that will swing and produce a predetermine light and sound effect on a decorative object driven electronically to improve the visual effect, aesthetic feeling, and interesting structure. The base of a support stand provides an accommodating space for receiving at least one electronic driver disposed on a pair of vertical stands of the base, and electrically coupled to a power supply as a medium of constructing and connecting to a power supply; at least one swinging member, being extended from a swinging axle rod and movably coupled to the vertical stand and electrically coupled to a power supply for electric connection, a weight member and at least one decorative member are disposed on a swinging stand, and the decorative member has at least one sound and light member inside and electrically coupled to the swinging stand. By means of the power supply of the medium through the vertical stand and the driving operation of the electronic driver, the decorative member will produce a predetermined flash of light or generate a predetermined sound when the decorative member is swinging.

### FIELD OF INVENTION

The present invention relates to a sound and light swinging device, more particularly to a swinging device that will swing and produce a predetermine light and sound effect on a decorative object driven electronically to improve the visual effect, aesthetic feeling, and interesting structure.

### BACKGROUND OF THE INVENTION

In general, a conventional swinging decorative unit (toy) comprises a decorative member, a weight member, a swinging member on which the decorative member and the weight member disposed, and a pair of swinging axle rod of the swinging member for directly setting a pair of vertical stands on a base, such that the vertical stand acts as a support and an axle center for the swing. When an external force is exerted on the swinging member, the axle of the swinging axle rod on the vertical stand works together with the swinging member and the weighted member for the interaction to swing the decorative members back and forth and attain an interesting effect. However such design of the structure is simply limited to an axial swinging effect, and does not have any special sound and light effect. Such arrangement totally depends on the style of the decorative member to obtain the decorative effect.

Another kind of swinging decorative unit (toy) was also disclosed in the R.O.C. Utility Patent No. 136496 (Publication No. 334838) regarding a structure of the back and forth circumrotating swinging toy, which basically provides an inner space by a base to install an mechanism of electromagnetic field, and the surface of the base has a pair of support stands for pivotally coupled a transversal rod of the swinging structure. The swinging structure has a plurality of link rods, each is installed onto the swinging member; some of the swinging members have an object of magnetic field inside. The swinging structure is directly disposed in the groove edge of the support stand excessively by the transversal rod. The magnetic action between the mechanism of electromagnetic field and the swinging member having an object of magnetic field drives the swinging structure to produce a circumrotating swing. Such structural design can only improve the control of the swing or gain the continuity of the swing, but is lack of special and unique sound or light effects.

### SUMMARY OF THE INVENTION

The primary objective of the present invention is to provide a sound and light swinging device, comprising:

A support stand, having a pair of vertical stands disposed on a base, and one end of the vertical stand being extended into the base for an electrical coupling, and an open installing area being disposed at the end of the vertical stand;

At least one set of swinging member, extending a pair of swinging axle rods for movably coupling to the vertical stand and connecting to the power supply, and the body of a swinging stand each having a weighted member and at least one decorative member, and said decorative member has at least one sound and light member inside for being electrically coupled to the swinging stand;

At least one set of electronic driver, being electrically coupled to and driving the sound and light member;

By means of having at least one set of sound and light member in the space provided the swinging member, and directly using the vertical stand as the medium of electric conduction, the power supply in the base is conducted to the swinging stand of the swinging member for supplying the power supply required by the operation of the illuminating member; the electronic driver in the base of the support stand driving the sound and light member to light up, flash, or produce sound according to the swinging of the swinging device according to the working mode under the control conditions to obtain a totally different swinging device having a sound and light swinging decoration and interesting effect.

To provide a further understanding of the invention, the following detailed description illustrates embodiments and examples of the invention, this detailed description being provided only for illustration of the invention.

### BRIEF DESCRIPTION OF THE DRAWINGS

FIG. 1 is a cross-sectional diagram of the assembled structure according to the first embodiment of the present invention.

FIG. 2 is a side-view diagram of the assembled structure according to the first embodiment of the present invention

FIG. 3 is a circuit diagram of a manual electronic driver according to the first embodiment of the present invention.

FIG. 4 is a circuit diagram of the light controlling electronic driver according to the first embodiment of the present invention.

FIG. 5 is a circuit diagram of the sound controlling electronic driver according to the first embodiment of the present invention.

FIG. 6 is an illustrative diagram of the flash movement according to the first embodiment of the present invention.

FIG. 7 is a cross-sectional diagram of the assembled structure according to the second embodiment of the present invention.

FIG. 8 is an illustrative diagram of the inclined state according to the second embodiment of the present invention.

### DETAILED DESCRIPTION OF THE PREFERRED EMBODIMENTS

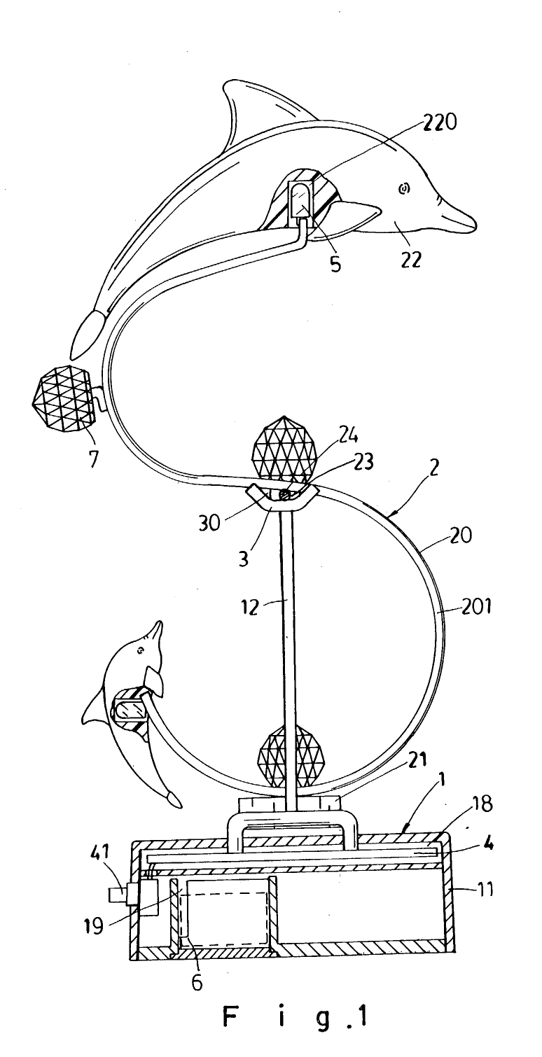

Refer to FIGS. 1 to 3 for the structure of a first embodiment of the present invention. In FIG. 1, the structure according to the embodiment of the present invention comprises a support stand 1, being in the form of various styles and shapes, and a swinging member 2 for being mounted and exerted with force for swinging, and working together with an electronic driver 4 of the power supply; wherein:

Said support stand 1 comprises a base 11, providing a accommodating space 18 for disposing at least one set of electronic driver 4 and an electric chamber 19 for accommodating and hiding a power supply member 6 (as shown in FIG. 1); of course, said electric chamber 19 and electronic driver 4 could be directly disposed in the indented space 220 provided by the decorative member 22; said base 11 comprises a pair of vertical stands 12 being symmetrically extended upward from an appropriated position on the surface of the base 11, and said vertical stand is recommend to adopt good electrically conductive materials; a pair of vertical stands 12 are extended from one end of the base 11 and respectively electrically coupled to the electronic driver 4 and the power supply such that the pair of vertical stands 12 forms a medium for connecting and controlling a power supply for the swinging member 2; the two vertical stands 12 define a space as the swinging space, wherein the upper end positions of the pair of vertical stands appropriately provide an installing area 3, which provides an axially installing space 30 for installing and coupling the swinging member 2 as a swinging axle center and operating and controlling the power supply;

Said installing area 3 comprises an axial installing space 30, being an open axial installing space which adopts a V-shaped axle stand as shown in FIG. 1) to provide the axial installation of the swinging rod 23 of the swinging member 2 and the operating position of the rotation of the axle;

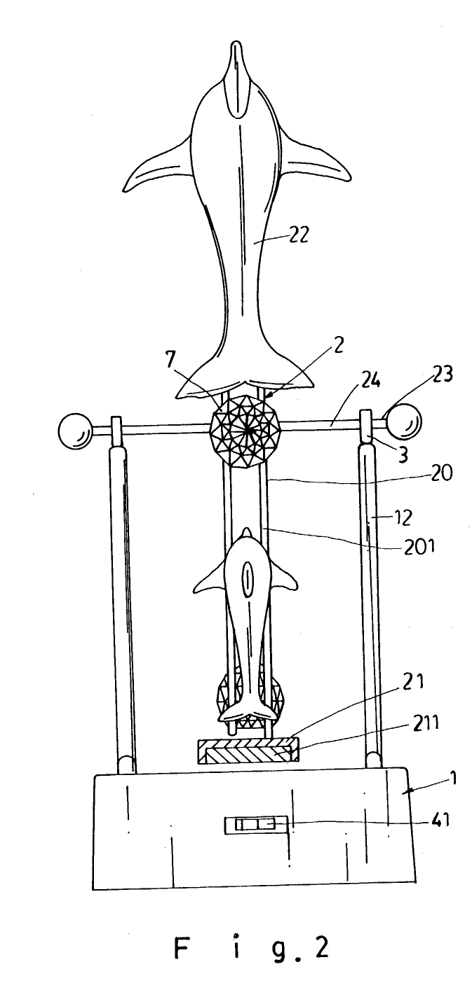

At least one set of swinging member 2, comprising a swinging stand 20 of various styles and shapes according to its design, which is composed by two parallel stand rods 201 separately connected to the electric power (as shown in FIG. 2) to prevent the short-circuit of the power supply; both ends of the swinging stand 20 and the stand at a chosen position respectively has a weighted member 21 and a magnetic member 211 such as a magnet is disposed at its bottom if needed (as shown in FIG. 2); and at least one decorative member 22; a swinging axle rod 23, also could be of any stylish design, but at least having two horizontal axle ends 24, and said two ends 24 having two stand rods 201 laterally extended from the equilibrium position of the swing stand 20 with two stand rods 201 between the weighted member 21 and the decorative member 22 for pivotally coupling the member 3 for normal contact of electric connection. In the meantime, at least one electrically insulating reinforced member 7 (as shown in FIG. 1) is disposed at an appropriate position between the styling shape and length of the swinging stand 20; said reinforced member 7 is bridged between two separate electrically connected stand rods 201 to obtain a reinforcement of two parallel conductive stand rods 201 and prevent them from being deformed.

Said decorative member 22 (as shown in FIG. 1) provides at least one inwardly concave space 220 as the installing position of the sound and light member 5, and the power supply ends of said light and sound member 5 are electrically coupled to the two stand rods 201 of the swinging stand 20 respectively for supplying the power required for the operation; said sound and light member 5 basically use an electronic illuminating device such as an LED or a small bulb, etc for the light, and an electronic audio member such as an audio chip for the sound; said sound and light member 5 can be installed separately, jointly, or synchronously depending on the design and individual requirement, and the electronic audio device can be jointly installed on the same circuit board with the electronic driver 4 for the electrical drive and control.

Furthermore, the weighted member 21, decorative member 22, and the reinforced member 7 may use different styling and it is recommended to adopt various insulating materials to prevent the short circuit of the power supply.

At least one set of electronic driver 4 is fixed in the accommodating space 18 provided by the base 11 and electrically coupled with the vertical stand 12. Of course, said electronic driver 4 can also be installed directly in the space 220 provided by the decorative member 22 and jointly installed with the sound and light member 5; the setting of the operation of the electronic driver 4 works together with the swinging of the decorative member 22 to supply power and drive the lighting and sounding of the decorative member 22. The driving method of said electronic driver 4 can adopt the manual control, light control, or sound control separately or jointly.

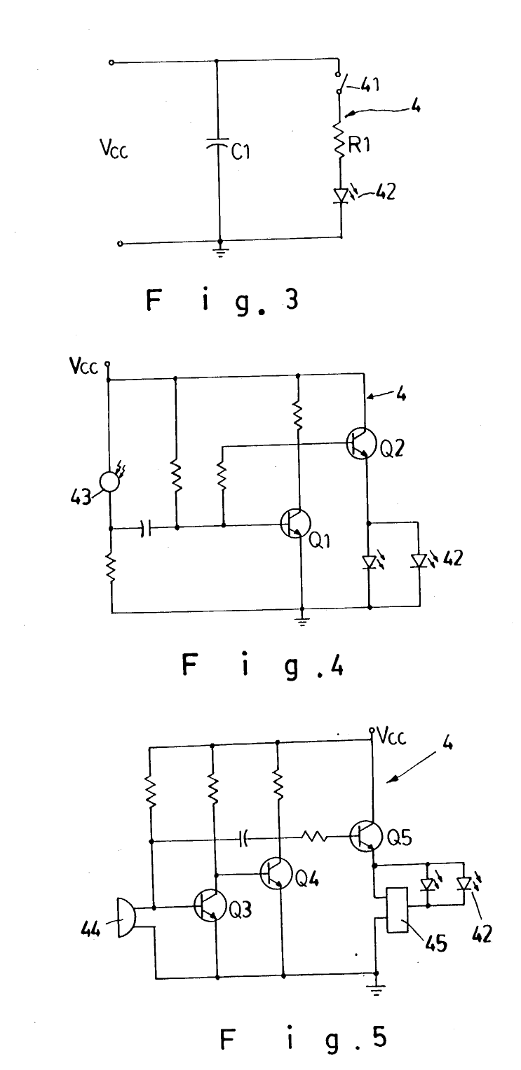

Please refer to FIG. 3 for the circuit design of the foregoing manual driving driver 4; in such circuit, the sound and light member 5 adopts an electronic illuminating LED device for the description. A manual switch 41 works with a resistor R1 and capacitor C1 and an electronic illumining LED device 42 electrically coupled with each other such that the electronic illuminating LED device 42 can be connected to power and turned on.

In addition to providing the connection of continuous electrical power for the illumination, such illuminating method of the electronic illuminating device LED 42 can also work with an electronic flash member (IC) (not shown in the figure) and a vibration switch 41 such that a manual electronic illuminating LED device 42 match up with the swinging movement and the set swinging position under the condition of being supplied with power. The vibration switch 41 is turned on, so that the electronic illuminating LED device 42 and the electronic flash member (IC) to produce the blinking light.

Please refer to FIG. 4 for the circuit design; the sound and light member 5 in the circuit adopts an electronic illuminating LED device, and the light-sensing control driver 4 is taken as example for the description. A light-sensor 43 (a CDS light-sensing electronic device is used for description) as the sensor to the variation of the light in the environment to generate driving signals to drive a transistor Q1, Q2 in order to control the electronic illuminating LED device 42 to light up and blink.

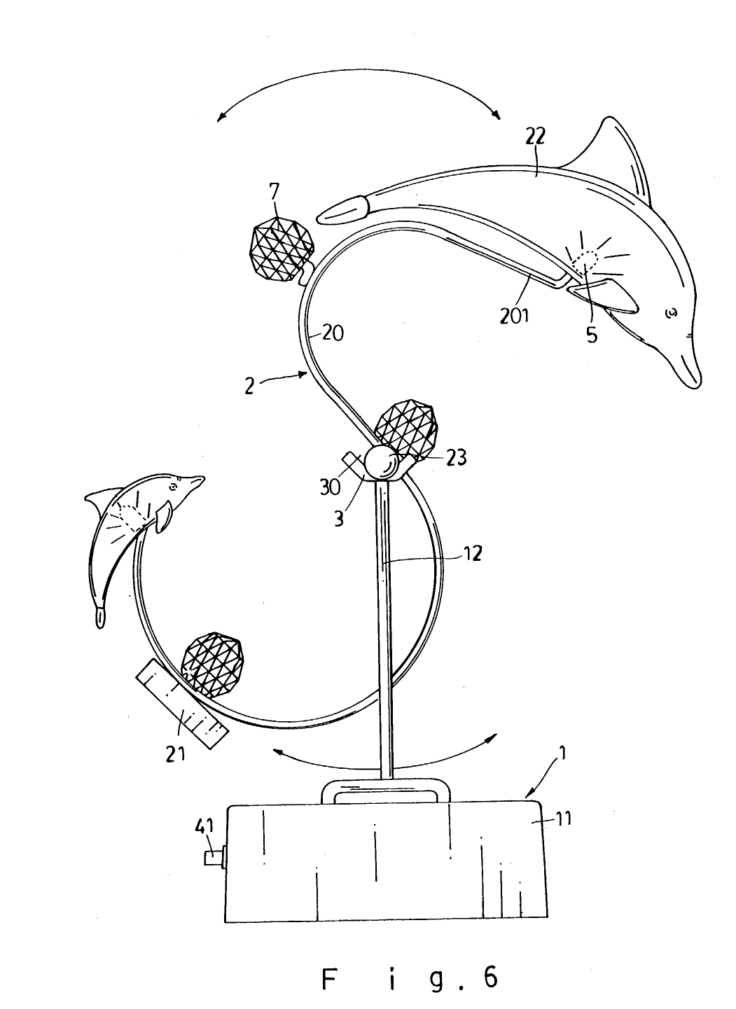

Please refer to FIG. 5 for the circuit design of the foregoing sound control electronic driver 4 for the description. An audio receiving device 44 is used for the receiving of external control sound to generate driving signals to drive a transistor Q3, Q4, Q5 and a sound control electronic flash IC 45 in order to control the electronic illuminating LED device 42 to work and light up or blink. Such sound driven electronic driver 4 may use the delay circuit as the design of the sound control.

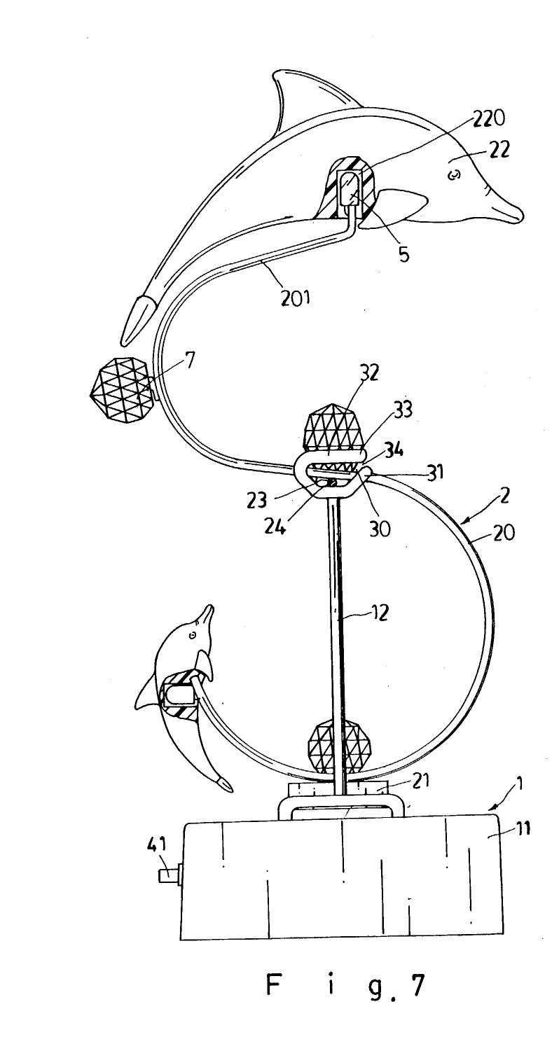

Such assembly according to the above embodiment of the present invention as shown in FIGS. 1 and 2 takes an open vertical stand assembly for description. The space 220 provided by the inwardly concave decorative member 22 comprises at least a set of sound and light member 5 acting as a conductive medium directly through the vertical stand 12 to conduct the power in the base 11 to the swinging stand 20 of the swinging member 2 and supply the power required for the operation of the sound and light member 5 and the electronic driver 4 disposed on the support stand 1 in the base 11. Under the set control conditions and driving module, it drives the sound and light member 5 to light up, flash, or produce sound to cope with the swing of the swinging stand as shown in FIG. 6 and obtain a swinging device with decoration and interesting effects totally different from the traditional ones.

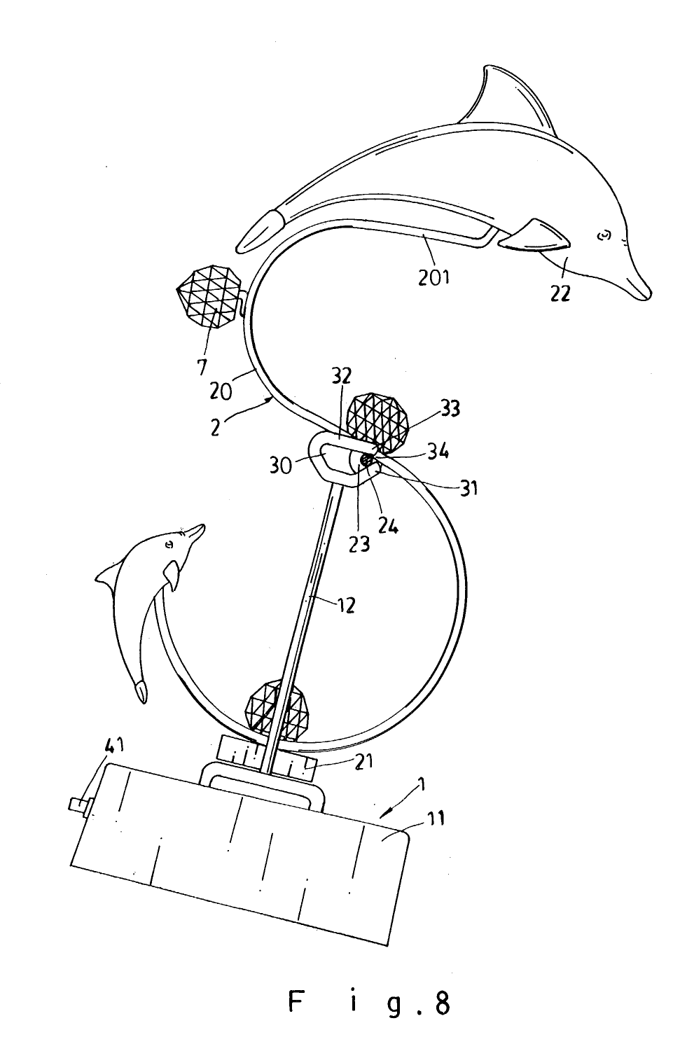

Various other modifications and changes may be made to the structure and contents without departing from the true spirit and scope of the present invention, so that the present invention can have the foregoing sound and light effect and also fit various environments to install the swinging device and prevent the swinging member 2 from falling off. Such structure comprises a sound and light member 5 of a swinging member 2, and a support stand 1 having an electronic driver 4 and a power supply in the base 11 as shown in FIG. 7, wherein:

The end surface of said base 11 same as the previous embodiment has a pair of vertical stands 12 electrically coupled to an electronic driver 4 and a power supply. An installing area 3 at the ends of the vertical stand 12 provides an incompletely open restrictive space 30 (as shown in FIG. 7) for pivotally coupling to the swinging axle for installing a swinging axle rod 23 of the swinging member 2 without the risk of letting it detach from the axle stand and the operating position of the axle.

Said incompletely open restrictive space 30 for pivotally coupling to the swinging axle is an axle component 31, which is in an arc shape, and the V-shape one is most preferred. Such axle component 31 provides the necessary axle stand and the position for operating the axle movement, and a surrounded by a positioning component 32. Such positioning component 32 could be a linear rod, or an axle component having a shape similar or identical to the axle, or any other shape. One end of the positioning component 32 is exactly coupled to the end of the axle component 31 as an integral close assembly, and the opening end 33 of the positing component 32 forms a non-sealed opening 34 at an end of the axle component 31. The diameter of said opening 34 is preferred to be slightly smaller than the diameter of the swinging axle rod 23 of the swinging member 2, such that the swinging axle rod 23 of the swinging member 2 can be installed into the installing space 30 through said opening 34 with a gently pressing on the diameter of the opening, and thereafter the opening will resume its original diameter slightly smaller than the diameter of the axle end 24 of the swinging axle rod 23, but is not limited to such arrangement. Of course the opening 34 may have a diameter equal or slightly larger than the diameter of the axle end 24 of swinging axle rod 23.

Said space 30 provided by the swinging axle rod 23 of the swinging member 2 has a size sufficient to allow a smooth swinging of the axle set fro the swinging axle rod 23 and the axle end 24, and preferred to have a diameter of 1.5˜2 times of the axle end 24. Of course, said space 30 can use an incompletely sealed opening 34, as well as a fully sealed one; the set of axle component member 31 and the positioning component 32 are comprised of a fully sealed space with both ends connected to accomplish the same effect of coupling the swinging rod 23 and preventing it from falling off.

Please refer to FIG. 7 for the preferred embodiment of the present invention. In addition to the sound and light swinging effect of the first preferred embodiment, such assembly also has a swinging member 2 and an installing area 3 to form an integral restrictive assembly such that the swinging member 2 is restricted into the space 30 for the swinging. Under the restriction of the incompletely sealed opening 34 or fully sealed space 30 of the axle swinging set, the swinging member 2 will not be separated from the support stand 1 even in the inclined condition (as shown in FIG. 8) to break through the traditional way that can be placed on a position of a static plane. Even in the dynamic environment (such as in a car) or in general static environment or uneven surface, the swinging decorative unit of the present invention can be installed to obtain the swing and sound and light interesting effects as well as the decorative effect. Such arrangement also can prevent the components from falling off. In the meantime, the swinging member 2 swings in the support stand 1 with sound and light effects even the force exerted and the swinging amplitude is too large.

Said support stand 1 can work with various assembly accessories, so that it can go with different assembling environments, such as directly placing or fixing it (such as by gluing and the like) on a static or dynamic (such as in the car) position corresponding to the bottom of the base 11; or the base 11 works with a fixture to directly dispose it in various static or dynamic positions (such as in the air-conditioner outlet in the car) by clipping, or works with a suspending component (such as a hanging string or hook, etc) of the base 11 to directly dispose it in various static or dynamic positions (such as in the air-conditioner outlet in the car or other position) by hanging. Of course, the base 11 can also work with other different assemblies to accomplish different installations for different environmental spaces.

Those skilled in the art will readily recognize that these and various other modifications and changes may be made to the present invention without strictly following the exemplary application illustrated and described herein and without departing from the true spirit and scope of the present invention, which is set forth in the following claims.

What is claimed is:

1. A sound and light swinging device, comprising:
A support stand, comprising a pair of vertical stand on a base, each vertical stand having one end extending and being electrically coupled to the base inside; and an open installing area disposed on one end of the vertical stand;
At least one set of swinging member, and an swinging stand extending a pair of swinging axle rod for movably coupling to a vertical stand and supplying power, and said swinging stand comprising a weighted member and at least one decorative member; said decorative member has at least one sound and light component electrically coupled with the swinging stand;
At least one set of electronic driver, electrically coupled with the driving sound and light component;
By means of having at least one sound and light component disposed in the space provided by the decorative member, said swinging device is disposed in and being driven by the electronic driving device in the base that works together with the swinging of the swinging stand under the driving operation mode to light up or flash or produce sound in order to accomplish the swinging decoration and interesting effects unlike the conventional swinging devices.

2. The sound and light swinging device of claim 1, wherein said base of the support stand provides an accommodating space for installing an electronic driver and an electric chamber for accommodating and hiding a power supply.

3. The sound and light swinging device of claim 1, wherein said pair of vertical stands of the base having one end extended into the accommodating space and being electrically coupled to the electronic driver and the power supply.

4. The sound and light swinging device of claim 1, wherein said vertical stand and swinging stand of the swinging member are made of an electrically conductive material.

5. The sound and light swinging device of claim 1, wherein said swinging stand of the swinging member is comprised of two separate parallel stand rods to prevent short circuit to the power supply, and are in different styling shapes according to its design.

6. The sound and light swinging device of claim 1, wherein said decorative member provides at least one inwardly concave space as the position for installing the sound and light component, and the power supply end of sound and light component are electrically coupled to the two stand rods respectively to supply the necessary power for the operation.

7. The sound and light swinging device of claim 6, wherein said sound and light member is an electronic illuminating component such as a LED and a small bulb.

8. The sound and light swinging device of claim 7, wherein said electronic illuminating component works with an electronic flash IC to produce a flashing effect.

9. The sound and light swinging device of claim 6, wherein said sound and light member is an electronic audio device such as an audio chip.

10. The sound and light swinging device of claim 9, wherein said electronic audio component is directly disposed on the circuit board with the electronic driver for the controlling and driving.

11. The sound and light swinging device of claim 6, wherein said electronic illuminating component is synchronously coupled with the electronic audio device.

12. The sound and light swinging device of claim 1, wherein said weighted member and decorative member adopt various styles and use various electrically insulating material to prevent the short circuit of the power supply.

13. The sound and light swinging device of claim 1, wherein said electronic driver is disposed in the accommodating space of the base, and electrically coupled with the vertical stand directly.

14. The sound and light swinging device of claim 1, wherein said electronic driver and electric chamber with power supply are disposed in the inwardly concave space provided by the decorative member and electrically coupled to the power supply directly through the swinging stand.

15. The sound and light swinging device of claim 13, wherein said electronic driver disposed in the accommodating space in the base is a manual electronic driver and being turned on and off by the control of a switch of the sound and light member

16. The sound and light swinging device of claim 13, wherein said control switch of the manual control electronic driver electronic driver is a vibrating switch to work with the swinging and the swinging position to drive the sound and light member.

17. The sound and light swinging device of claim 13, wherein said electronic driver disposed in the accommodating space of the base is a light-control electronic driver that drives the sound and light component by sensing of the variation of external light.

18. The sound and light swinging device of claim 13, wherein said electronic driver disposed in the accommodating space of the base is a sound-control electronic driver that drives the sound control IC by receiving sound from a sound receiving component to start the operation of the sound and light member.

19. The sound and light swinging device of claim 13, wherein said electronic driver is a combination of any two selected from the collection of the manual driven, light-control, and sound control.

20. A sound and light swinging device, comprising:
a support stand, comprising a pair of vertical stands on a base, each vertical stand having one end extending and providing an incompletely sealed open installing area on one end of the vertical stand;
at least one set of swinging member, and an swinging stand extending a pair of swinging axle rod for movably coupling to a vertical stand and supplying power, and said swinging stand comprising a weighted member and at least one decorative member; said decorative member has at least one sound and light component electrically coupled with the swinging stand;
at least one set of electronic driver, electrically coupled with the driving sound and light component;
by means of having at least one sound and light component disposed in the space provided by the decorative member and directly providing the power supply for the operation through the vertical stand acting as the electrically conductive medium and controlled by electronic driving device in the base that works together with the swinging of the swinging stand under the driving operation mode to light up or flash or produce sound in order to accomplish the swinging decoration and interesting effects unlike the conventional swinging devices, and the restrictive swinging member in the incompletely open installing area can be applicably installed in various dynamic and static environments for the interesting and decorative effects.

21. The sound and light swinging device of claim 20, wherein said space provided by the incompletely open axle swinging set is comprised of an axle component and a positioning component surrounded thereof.

22. The sound and light swinging device of claim 21, wherein said positioning component having one end integrally coupled with an end of the axle component to define a close status, and the other end of the positioning component forms a non-sealed opening with one end of the axle component, and encloses an incompletely sealed space of an axle swinging assembly.

23. The sound and light swinging device of claim 22, wherein said incompletely sealed space of the axle swinging assembly has a diameter slightly smaller than the diameter of the axle end of the axle swinging assembly.

24. The sound and light swinging device of claim 23, wherein said incompletely sealed space of the axle swinging assembly has a diameter equal to or slightly larger than the diameter of the axle end of the axle swinging assembly.

25. The sound and light swinging device of claim 21, wherein said axle component and positioning components are comprised of a fully sealed space with both ends connected to couple the axle rod and prevent it from falling off.

26. The sound and light swinging device of claim 21, wherein said axle component is an arc member preferably in a V-shape.

27. The sound and light swinging device of claim 21, wherein said positioning member is a linear rod.

28. The sound and light swinging device of claim 21, wherein said positioning member is an arc member preferably in a V-shape.

29. The sound and light swinging device of claim 27, wherein said positioning member is in other shape.

30. The sound and light swinging device of claim 20, wherein said space provided by the incompletely sealed axle swinging assembly has an enough space for a smooth swing of the swinging rod, preferably having a diameter of 1.5˜2 times of the axle end of the swinging rod.
